(19) United States
(12) Patent Application Publication
(10) Pub. No.: US 2016/0060425 A1
(43) Pub. Date: Mar. 3, 2016

(54) RECYCLABLE, GREASE RESISTANT PACKAGING

(71) Applicant: NOVA Chemicals (International) S.A., Fribourg (CH)

(72) Inventors: Daniel J. Falla, Sarnia (CA); Shivendra Kumar Goyal, Calgary (CA); Bronwyn Hilary Gillon, Calgary (CA); Barney Quong, Calgary (CA)

(73) Assignee: NOVA Chemicals (International) S.A., Fribourg (CH)

(21) Appl. No.: 14/842,005

(22) Filed: Sep. 1, 2015

(30) Foreign Application Priority Data
Sep. 2, 2014 (CA) 2861669

(51) Int. Cl. C08K 5/098

(52) U.S. Cl. CPC C08K 5/098

(57) ABSTRACT

Grease resistant packaging is prepared from a high density polyethylene (HDPE) composition that contains a nucleating agent. Outstanding results are observed when the nucleated HDPE composition is included in an internal layer of a multilayer packaging structure. The use of HDPE that is prepared with a chromium or titanium (especially titanium) containing catalyst is preferred. The packaging may be in the form of a monolayer film, a multilayer film, a sheet or a molded part.

### FIELD OF DISCLOSURE

This disclosure relates to recyclable grease resistant packaging.

### BACKGROUND OF THE DISCLOSURE

Grease is known to permeate through most inexpensive packaging materials such as paper and cardboard.

This problem is typically addressed through the use of metallic containers, metalized films or the use of polymers containing polar comonomers such as poly (ethylene vinyl alcohol) (EVOH), polyamide, polyethylene terephthalate (PET) and polyvinylidene chloride (PVDC). These polymers are comparatively expensive.

Polyethylene is also used to prepare comparatively inexpensive packaging having moderate grease resistance.

Most notably, a particular type of high density polyethylene HDPE that is prepared with a chromium catalyst (“Cr catalyzed HDPE”) has been recommended for this application for many years. However, the performance of Cr catalyzed PE is not as good as that of the above mentioned polar polymers. It is also known to prepare multilayer packages which contain one or more layers of polyethylene and one or more layers of EVOH, PET, or PVDC in order to optimize the cost/performance balance. However, these multilayer structures can't be easily recycled because of the use of both polyethylene and a polar polymer.

We have now discovered that the grease resistance of HDPE can be improved with the use of a nucleating agent. Excellent results are observed when a layer of nucleated HDPE is used as an internal layer of a multilayer structure. The best results have been observed when using a polyethylene that is prepared with a titanium catalyst. This disclosure allows the production of a recyclable, grease resistant packaging having improved performance.

### SUMMARY OF DISCLOSURE

In one embodiment, the present disclosure provides a method for improving the grease breakthrough resistance of a polyethylene package, said method comprising:

contacting grease with a package having at least one layer that is prepared from a compound comprising

a high density polyethylene composition having a density of from about 0.95 to about 0.97 g/cc; and

a nucleating agent in an amount of from about 500 to about 5000 parts per million by weight, based on the weight of said high density polyethylene composition;

wherein said package has an improvement in grease breakthrough resistance in comparison to a package that is made from the same high density polyethylene composition but does not contain said nucleating agent.

### DETAILED DESCRIPTION OF EMBODIMENTS

The present disclosure combines a high density polyethylene (HDPE) composition (which is described in Part A, below) and a nucleating agent (Part B) to form a grease resistant package.

### HDPE Composition

The HDPE composition has a density of from about 0.95 grams per cubic centimeter (g/cc) to about 0.97 g/cc as determined by ASTM D1505. A single HDPE may be used but we have observed exceptionally good results when using a blend of different HDPEs (described below).

HDPE is a well-known and widely available item of commerce. It is prepared with a transition metal catalyst (typically Cr, Ti, V or Zr) and may be prepared under gas phase, slurry or solution polymerization conditions.

The first type of HDPE that was commercially available on a wide basis was prepared with a chromium (Cr) catalyst and that type of HDPE still predominates the HDPE market. The use of such HDPE (hereinafter “Cr catalyzed HDPE”) to prepare packaging for greasy materials is well known. For example, a particular grade of Cr catalyzed HDPE sold under the trademark NOVAPOL™ HF-Y450 is recommended for the preparation of grease resistant packaging. However, performance of this HDPE is inferior relative to structures containing EVOH, PET, or PVDC in at least one layer.

HDPE is also produced with Group IV transition metals catalysts, i.e. Ti, Zr, Hf and Rf. For reasons that are not completely understood, the grease breakthrough resistance of these HDPE resins is especially good when used with a nucleating agent (i.e. when using a nucleating agent, the best results are obtained with an HDPE that is prepared with a Group IV transition metal catalyst—especially Ti).

The HDPE composition of this disclosure may be further characterized by having a melt index, I₂, of from about 0.01 to about 100 grams per 10 minutes (as determined by ASTM D1238 at 190° C., using a 2.16 kg load). In other embodiments, a melt index of from about 0.01 to about 10 may be preferred.

As previously noted, the HDPE composition may be a blend of two or more different HDPE resins. Such a blend may be prepared by a solution polymerization process using two reactors that operate under different polymerization conditions. This provides a uniform, in situ blend of the HDPE blend components. An example of this process is described in published U.S. Pat. No. 7,737,220 (Swabey et al.). The use of the “dual reactor” process also facilitates the preparation of blends which have very different melt index values. In one embodiment, the blend is prepared by a dual reactor process and comprises a first HDPE blend component having a melt index (I₂) value of less than about 0.5 g/10 minutes (especially from about 0.01 to about 0.4 g/10 minutes) and a second HDPE blend component having an I₂ value of greater than about 100 g/10 minutes. In another embodiment, the second HDPE component has an I₂ in excess of about 1000 g/10 minutes. In one embodiment, the amount of the first HDPE blend component of the blends is from about 40 to about 60 weight % (with the second blend component making the balance to 100 weight %). In one embodiment, the overall blend of the HDPE composition has a MWD (Mw/Mn) of from about 3 to about 20 and an overall melt index of from about 0.5 to about 10 g/10 minutes. In another embodiment, at least one of the blend components has a narrow molecular weight distribution, Mw/Mn, of from about 2 to about 3. In a one embodiment, the high density polyethylene composition has a density of from about 0.96 to about 0.97 g/cc.

### B. Nucleating Agents

The term nucleating agent, as used herein, is meant to convey its conventional meaning to those skilled in the art of preparing nucleated polyolefin compositions, namely an additive that changes the crystallization behavior of a polymer as the polymer melt is cooled.

A review of nucleating agents is provided in U.S. Pat. Nos. 5,981,636; 6,465,551 and 6,599,971.

Examples of conventional nucleating agents which are commercially available and in widespread use as polypropylene additives are the dibenzylidene sorbital esters (such as the products sold under the trademark Millad™ 3988 by Milliken Chemical and Irgaclear™ by Ciba Specialty Chemicals).

The nucleating agents should be well dispersed in the HDPE. The amount of nucleating agent used is comparatively small—from about 500 to about 5000 parts by million per weight (based on the weight of the HDPE) so it will be appreciated by those skilled in the art that some care must be taken to ensure that the nucleating agent is well dispersed. It is preferred to add the nucleating agent in finely divided form (less than about 50 microns, especially less than about 10 microns) to the polyethylene to facilitate mixing. This type of “physical blend” (i.e. a mixture of the nucleating agent and the resin in solid form) is generally preferable to the use of a “masterbatch” of the nucleator (where the term “masterbatch” refers to the practice of first melt mixing the additive—the nucleator, in this case—with a small amount of HDPE resin—then melt mixing the “masterbatch” with the remaining bulk of the HDPE resin).

Examples of nucleating agents which may be suitable for use in the present disclosure include the cyclic organic structures disclosed in U.S. Pat. No. 5,981,636 (and salts thereof, such as disodium bicyclo[2.2.1]heptene dicarboxylate); the saturated versions of the structures disclosed in U.S. Pat. No. 5,981,636 (as disclosed in U.S. Pat. No. 6,465,551; Zhao et al., to Milliken); the salts of certain cyclic dicarboxylic acids having a hexahydrophtalic acid structure (or “HHPA” structure) as disclosed in U.S. Pat. No. 6,599,971 (Dotson et al., to Milliken); phosphate esters, such as those disclosed in U.S. Pat. No. 5,342,868 and those sold under the trade names NA-11 and NA-21 by Asahi Denka Kogyo and metal salts of glycerol (especially zinc glycerolate). The accompanying examples illustrate that the calcium salt of 1,2-cyclohexanedicarboxylic acid, calcium salt (CAS registry number 491589-22-1) provides exceptionally good results.

### Grease Breakthrough Resistance

The packages of this disclosure provide improved grease breakthrough resistance in comparison to a package that is made from the same composition but absent the nucleating agent.

As used here, the term grease includes animal and vegetable based fats and oils and mineral-derived oils and greases. The term is inclusive of fats and oils composed of triglycerides (esters of glycerol with fatty acids) and accompanying fatty substances, e.g., sterols of animal or plant origin, tocopherols, carotenoids, and phenolic compounds. The differentiation between fats (solid) and oils (liquids) are their physical states at room temperature. The physical properties are determined by the chain length and the number of cis-C═C double bonds in the fatty acid parts of the triglycerides. Longer chains and saturated fatty acids lead to higher melting points while shorter chains and unsaturated fatty acids result in lower melting points.

Non-limiting examples of vegetable oils include sunflower, olive, coconut, palm, palm kernel, cottonseed, wheat germ, soybean, corn, safflower oil, hemp oil, canola/rapeseed, avocado, and fully or partially hydrogenated vegetable oil/shortening.

Non-limiting examples of animal fats include lard/pork/strutto, duck fat, and chicken, and tallow/beef. The present disclosure is not intended to include packages for dairy products such as milk, cream or butter. The use of linear low density polyethylene to prepare packaging for milk is well known and is described, for example, in U.S. Pat. Nos. 4,521,437 and 6,256,966.

Other greases include rosin, petroleum jelly, petrolatum, white petrolatum, soft paraffin/multi-hydrocarbon, hydrocarbon waxes/paraffin, wheel bearing grease, engine oil, asphalt, and petroleum grease.

### Applications

This disclosure generally relates to improvements to a polymeric package or container used to contain oily or greasy products. Non-limiting examples of such products include:

Soup

Nuts

Oils used in food applications

Nut butter

Fried goods (e.g. potato chips)

Other non-limiting examples include:

Pet food (e.g. proteins, cereals, grains and seeds)

Asphalt packaging

Motor oil, greases and lubricants.

Frequently, such packages are call food packages, or food containers, or pet food packages, or pet food containers, or oil packages, or petroleum packages, or grease packages; larger and heavier packages may also be called heavy duty sacks or heavy duty packages or heavy duty containers. In the case of embodiments comprising films, the film thickness may span a wide range of thicknesses; non-limiting examples include, film thicknesses from about 0.5 mil (13 μm) to about 4 mil (102 μm), in heavy duty sack applications film thickness may range from about 2 mil (51 μm) to about 10 mil (254 μm).

### Other Polymers and Package Structures

One embodiment of this disclosure includes a package or container comprising at least one layer containing a nucleated HDPE layer and optionally at least one other layer comprising linear low density polyethylene (LLDPE), low density polyethylene (LDPE), ethylene-vinyl acetate copolymers (EVA), ethylene styrene interpolymer (ESI), ultra low density polyethylene (ULDPE), plastomer PE, elastomer PE, metallocene catalyzed linear low density polyethylene (mLLDPE), homogeneously branched substantially linear ethylene interpolymer (HBSLEIP), single site catalyzed linear low density polyethylene (sLLDPE), and/or high density polyethylene (HDPE). The core may also contain ethylene acrylic acid copolymers (EAA) and/or ionomer resins, ethylene-ethyl acrylate copolymers (EEA), ethyl methyl acrylate copolymers (EMA). In an embodiment, the film may contain an abuse resistant layer and or a sealant layer. The terms “abuse resistant” and “sealant” are used in the conventional sense; non-limiting examples of sealant materials include sLLDPE, mLLDPE, HBSLEIP, LLDPE, ULDPE and EVA; non-limiting examples of abuse resistant layers include LLDPE, HDPE, ionomers, PET and polyamides.

### DEFINITION OF TERMS

Other than in the operating examples or where otherwise indicated, all numbers or expressions referring to quantities of ingredients, extrusion conditions, etc., used in the specification and claims are to be understood as modified in all instances by the term “about.” Accordingly, unless indicated to the contrary, the numerical parameters set forth in the following specification and attached claims are approximations that can vary depending upon the desired properties, which the present disclosure desires to obtain. At the very least, and not as an attempt to limit the application of the doctrine of equivalents to the scope of the claims, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

In order to form a more complete understanding of this disclosure, the following terms are defined and should be used with the accompanying figures and the description of the various embodiments throughout.

As used herein, the term “monomer” refers to a small molecule that may chemically react and become chemically bonded with an identical monomer or other types of monomers to form a polymer.

As used herein, the term “polymer” refers to macromolecules composed of one or more monomers connected together by covalent chemical bonds. The term polymer is meant to encompass, without limitation, homopolymers, copolymers, terpolymers, quatropolymers, multi-block polymers, graft copolymers, and blends and combinations thereof.

The term “homopolymer” refers to a polymer that contains one type of monomer.

The term “copolymer” refers to a polymer that contains two monomer molecules that differ in chemical composition randomly bonded together. The term “terpolymer” refers to a polymer that contains three monomer molecules that differ in chemical composition randomly bonded together. The term “quatropolymer” refers to a polymer that contains four monomer molecules that differ in chemical composition randomly bonded together.

As used herein, the term “ethylene polymer”, refers to macromolecules produced from the ethylene monomer and optionally one or more additional monomers. The term ethylene polymer is meant to encompass, ethylene homopolymers, copolymers, terpolymers, quatropolymers, block copolymers and blends and combinations thereof, produced using any polymerization processes and any catalyst.

Common ethylene polymers include high density polyethylene (HDPE), medium density polyethylene (MDPE), linear low density polyethylene (LLDPE),—including metallocene catalyzed LLDPE (or mLLDPE) and single site catalyzed LLDPE (sLLDPE), very low density polyethylene (VLDPE), ultralow density polyethylene (ULDPE), plastomer and elastomers; as well as ethylene polymers produced in a high pressure polymerization processes, commonly called low density polyethylene (LDPE), ethylene vinyl acetate copolymers (EVA), ethylene alkyl acrylate copolymers, ethylene acrylic acid copolymers and metal salts of ethylene acrylic acid (commonly referred to as ionomers).

The term “ethylene interpolymer” refers to a subset of the polymers in the “ethylene polymer” grouping that excludes ethylene homopolymers and ethylene polymers produced in a high pressure polymerization processes.

The term “heterogeneously branched ethylene interpolymers” refers to a subset of polymers in the “ethylene interpolymer” group characterized by a broad composition distribution breadth index (CDBI) of about 50% or less has determined by temperature rising elution fractionation (TREF). Heterogeneously branched ethylene interpolymers may be produced by, but are not limited to, Ziegler-Natta catalysts. Experimental methods, such as TREF, which are used to determine the CDBI of an ethylene polymer are well known to individuals experienced in the art (as described in U.S. Pat. No. 5,008,204 assigned to Exxon Chemical Patents, and in WO 93/03093, applicant Exxon Chemical Patents Inc.).

The term “homogeneous ethylene interpolymer” refers to a subset of polymers in the “ethylene interpolymer” group characterized by a narrow composition distribution breadth index (CDBI) of about 50% or more as determined by temperature rising elution fractionation (TREF). Homogeneous ethylene interpolymers may be produced by, but not limited to, single site catalysts or metallocene catalysts. It is well known to those skilled in the art, that homogeneous ethylene interpolymers are frequently further subdivided into “linear homogeneous ethylene interpolymers” and; “substantially linear homogeneous ethylene interpolymers”. These two subgroups differ in the amount of long chain branching: more specifically, linear homogeneous ethylene interpolymers have an undetectable amount of long chain branching; while substantially linear ethylene interpolymers have a small amount of long chain branching, typically from about 0.01 long chain branches/1000 carbons to about 3 long chain branches/1000 carbons. A long chain branch is defined as a branch having a chain length that is macromolecular in nature, i.e., the length of the long chain branch can be similar to the length of the polymer back-bone to which it is attached. Typically, the amount of long chain branching is quantified using Nuclear Magnetic Resonance (NMR) spectroscopy, as described in Randall “A Review of High Resolution Liquid 13C NMR of Ethylene Based Polymers”, J Macromol. Sci., Rev. Macromol. Chem. C29(2-3), 201-317 (1989). In this disclosure, the term homogeneous ethylene interpolymer refers to both linear homogeneous ethylene interpolymers and substantially linear homogeneous ethylene interpolymers.

The term “Ziegler-Natta catalyst” refers to a catalyst system that produces heterogeneous ethylene interpolymers. Ziegler-Natta (“Z/N”) systems generally contain, but are not limited to, a transition metal halide, typically titanium, (e.g. TiCl4), or a titanium alkoxide (Ti(OR)₄), where R is a lower C1-4 alkyl radical, on a magnesium support (e.g., MgCl2 or BEM (butyl ethyl magnesium) that is halogenated with, for example, CCl₄, to MgCl2 and an activator, typically an aluminum compound (AlX₄ where X is a halide, typically chloride), or a tri alkyl aluminum e.g. AIRS where R is a lower C1-8 alkyl radical such as trimethyl aluminum; or (RO)ₐAlX₃₋ₐ where R is a lower C1-4 alkyl radical, X is a halide, typically chlorine, and a is an integer from 1 to 3 (e.g., diethoxide aluminum chloride); or an alkyl aluminum alkoxide (e.g. RₐAl(OR)₃₋ₐ, where R is a lower C1-4 alkyl radical and a is as defined above (e.g., ethyl aluminum diethoxide). The catalyst may include an electron donor such as an ether (e.g., tetrahydrofuran etc.). There is a large amount of art disclosing these catalyst and the components and the sequence of addition may be varied over broad ranges.

The term “single site catalyst” refers to a catalyst system that produces homogeneous ethylene interpolymers. There is a large amount of art disclosing single site catalyst systems, a non-limiting example includes a bulky ligand single site catalyst of the formula:

(L)ₙ-M-(Y)ₚ

wherein M is selected from the group consisting of Ti, Zr, and Hf; L is a monoanionic ligand independently selected from the group consisting of cyclopentadienyl-type ligands, and a bulky heteroatom ligand containing not less than five atoms in total (typically of which at least 20%, preferably at least 25% numerically are carbon atoms) and further containing at least one heteroatom selected from the group consisting of boron, nitrogen, oxygen, phosphorus, sulfur and silicon, said bulky heteroatom ligand being sigma or pi-bonded to M; Y is independently selected from the group consisting of activatable ligands; n may be from 1 to 3; and p may be from 1 to 3, provided that the sum of n+p equals the valence state of M, and further provided that two L ligands may be bridged.

The packages of this disclosure may optionally include, depending on its intended use, additives and adjuvants, which can include, without limitation, anti-blocking agents, antioxidants, slip agents, processing aids, anti-static additives, colorants, dyes, filler materials, heat stabilizers, light stabilizers, light absorbers, lubricants, pigments, plasticizers, and combinations thereof.

Suitable anti-blocking agents, slip agents and lubricants include without limitation silicone oils, liquid paraffin, synthetic paraffin, mineral oils, petrolatum, petroleum wax, polyethylene wax, hydrogenated polybutene, higher fatty acids and the metal salts thereof, linear fatty alcohols, glycerine, sorbitol, propylene glycol, fatty acid esters of monohydroxy or polyhydroxy alcohols, hydrogenated castor oil, beeswax, acetylated monoglyceride, hydrogenated sperm oil, ethylene bis fatty acid esters, and higher fatty amides. Suitable lubricants include, but are not limited to, ester waxes such as the glycerol types, the polymeric complex esters, the oxidized polyethylene type ester waxes and the like, metallic stearates such as barium, calcium, magnesium, zinc and aluminum stearate, salts of 12-hydroxystearic acid, amides of 12-hydroxystearic acid, stearic acid esters of polyethylene glycols, castor oil, ethylene-bis-stearamide, ethylene-bis-cocamide, ethylene-bis-lauramide, pentaerythritol adipate stearate and combinations thereof in an amount of from about 0.1 wt % to about 2 wt % of the multilayer film composition.

Suitable antioxidants include without limitation Vitamin E, citric acid, ascorbic acid, ascorbyl palmitrate, butylated phenolic antioxidants, tert-butylhydroquinone (TBHQ) and propyl gallate (PG), butylated hydroxyanisole (BHA), butylated hydroxytoluene (BHT), and hindered phenolics such as IRGANOX® 1010 and IRGANOX 1076 available from Ciba Specialty Chemicals Corp., Tarrytown, N.Y.

Suitable heat stabilizers include, without limitation, phosphite or phosphonite stabilizers and hindered phenols, non-limiting examples being the IRGANOX® and IRGAFOS® stabilizers and antioxidants available from Ciba Specialty Chemicals. When used, the heat stabilizers are included in an amount of about 0.1 wt % to about 2 wt % of the multilayer film compositions.

Non-limiting examples of suitable polymer processing aids include fluoroelastomers such as poly(vinylidene fluoride-co-hexafluoropropylene), poly(vinylidene fluoride-co-hexafluoropropylene-co-tetrafluoroethylene), poly(vinylidene fluoride-co-tetrafluoroethylene-co-perfluoro(methyl vinyl ether)), poly(tetrafluoroethylene-co-perfluoro(methyl vinyl ether), polytetrafluoroethylene-co-ethylene-co-perfluoro(methyl vinyl ether) and blends of fluoroelastomers with other lubricants such as polyethylene glycol.

Suitable anti-static agents include, without limitation, glycerine fatty acid, esters, sorbitan fatty acid esters, propylene glycol fatty acid esters, stearyl citrate, pentaerythritol fatty acid esters, polyglycerine fatty acid esters, and polyoxethylene glycerine fatty acid esters in an amount of from about 0.01 wt % to about 2 wt % of the multilayer film compositions.

Suitable colorants, dyes and pigments are those that do not adversely impact the desirable physical properties of the multilayer film including, without limitation, white or any colored pigment. In embodiments of this disclosure, suitable white pigments contain titanium oxide, zinc oxide, magnesium oxide, cadmium oxide, zinc chloride, calcium carbonate, magnesium carbonate, kaolin clay and combinations thereof in an amount from about 0.1 wt % to about 20 wt % of the multilayer film. In embodiments of this disclosure, the colored pigment can include carbon black, phthalocyanine blue, Congo red, titanium yellow or any other colored pigment typically used in the industry in an amount from about 0.1 wt % to about 20 wt % of the multilayer film. In embodiments of this disclosure, the colorants, dyes and pigments include inorganic pigments including, without limitation, titanium dioxide, iron oxide, zinc chromate, cadmium sulfides, chromium oxides and sodium aluminum silicate complexes. In embodiments of this disclosure, the colorants, dyes and pigments include organic type pigments, which include without limitation, azo and diazo pigments, carbon black, phthalocyanines, quinacridone pigments, perylene pigments, isoindolinone, anthraquinones, thioindigo and solvent dyes.

In general, the packages of this disclosure may be prepared by any extrusion or molding process, including (but not limited to) extrusion molding, blow molding, calendaring, profile extrusion and injection molding.

Additional embodiments of this disclosure include the further processing of the inventive multilayer structure in extrusion lamination or adhesive lamination or extrusion coating processes. In extrusion lamination or adhesive lamination, two or more substrates are bonded together with a thermoplastic or an adhesive, respectively. In extrusion coating, a thermoplastic is applied to the surface of a substrate. The primary purpose of these processes are to combine dissimilar materials to produce a laminate that has the desirable properties of the various materials. For example, thermoplastic materials can be combined with dissimilar materials such as aluminum foil or paper; in addition, a high quality print or decoration layer can be protected by coating or laminating. Extrusion lamination, adhesive lamination and extrusion coating are well known processes, as described in: “Extruding Plastics—A Practical Processing Handbook”, D. V. Rosato, 1998, Springer-Verlag, pages 441-448.

Embodiments include the extrusion lamination of the disclosed structures to a secondary substrate. For example, structures comprising a nucleated HDPE extrusion laminated or adhesive laminated to a secondary substrate. Non-limiting examples of secondary substrates include; polyamide film, polyester film and polypropylene film. Secondary substrates may also contain a vapor deposited barrier layer; for example a thin silicon oxide (SiOₓ) or aluminum oxide (AlOₓ) layer. Secondary substrates may also be multilayer, containing three, five, seven, nine, eleven or more layers.

Embodiments also include the extrusion or adhesive lamination of the disclosed structures to a secondary substrate that is microlayered; wherein the term “microlayered” refers to structures (such as films) containing tens to thousands of individual thermoplastic layers. A non-limiting process to produce microlayered cast films is to use a layer multiplying feedblock as described in by Schrenk in U.S. Pat. Nos. 3,884,606, 5,094,788 and 5,094,793.

“Melt index” (also referred to as here as “I₂”) refers to the test value that is obtained by ASTM D1238 using the I₂ test conditions (i.e., tested at 190° C. using a 2.16 kg load) unless otherwise indicated. “Density” refers to the value that is obtained by ASTM D1505 unless otherwise indicated.

Embodiments include processes to manufacture the disclosed multilayer structures. In the first process step a coextrusion line is selected, comprising at least one extruder and a die. Coextrusion lines with two, three, five, seven, nine, or more extruders equipped with dies to produce blown or cast films or sheeting are well known to those skilled in the art. It is well known to those experienced in the art that chemically distinct compositions in the inner and outer skin layers are advantageous in many applications; in other words, the physical properties of the inner and outer skins differ, non-limiting examples of such physical properties include, coefficient of friction, blocking or antiblocking characteristics, seal initiation temperature or bond strength to a secondary substrate. The thickness of an individual layer within a multilayer structure may be about 5%, in other cases about 15% and in still other cases about 30% of the total multilayer structure thickness; in other embodiments, the thickness of an individual layer within a multilayer structure may be about 95%, in other cases about 80% and in still other cases about 65% of the total multilayer structure thickness.

The polyethylenes used in this disclosure may be homogenously branched (i.e., prepared with a single site catalyst and having a CDBI of at least 50) or heterogeneously branched (e.g., prepared with a Z/N or Cr catalyst) and may optionally contain long chain branching.

The following are examples of resins that could be used in the outside (possibly seal layer) of the mulitilayer package or container; one or more of a homogenously and/or heterogeneously branched linear ethylene interpolymer which may contain long chain branching (mLLDPE, sLLDPE, LLDPE), a LDPE, an EVA, a HDPE, an ionomer an EAA, an EMA, a polypropylene copolymer or terpolymer and a polypropylene homopolymer. By way of non-limiting example, a core may comprise:

from 0% to 100% by weight of linear ethylene copolymer inter polymerized from ethylene and at least one alpha olefin and having a density of about 0.870 g/cc to about 0.940 g/cc and a melt index of less than about 10.0 g/10 min, non-limiting examples of alpha olefin include linear and branched C3 to C18 alpha olefins;

from 0% to 100% of ethylene-vinyl acetate (EVA) copolymer having a weight ratio of ethylene to vinyl acetate from about 2:1 to about 24:1 and a melt index of from about 0.2 to about 10 g/10 min;

from 0% to 100% of mLLDPE or sLLDPE, either of which may contain long chain branching;

from 0 to 100% of non-nucleated HDPE, and;

from 0 to 100% of LDPE having a melt index of less than about 10 g/10 minutes and a density of less than about 0.93 g/cc.

Optionally, the core could also contain at least one layer containing:

from 0% to 100% of an ethylene acrylic acid copolymer having a weight ratio of ethylene to acrylic acid from about 2:1 to about 24:1 and a melt index of from about 0.2 to about 10 g/10 min, and;

from 0% to 100% of at least one polar polymer selected from Ionomer, EEA, and EMA.

### EXAMPLES

### Experimental

### Part 1

### 9-Layer Films

The resins used in this example are shown in Table 1; the reported melt index, I₂, and density values are from product datasheets of the respective resin grade as published by their manufacturers.

TABLE 1
Resin Properties

| Type | Melt Index, dg/min. | Density, g/cc |
|---|---|---|
| sLLDPE-1 | 0.65 | 0.916 |
| LLDPE-1 | 1.0 | 0.920 |
| sHDPE-1 | 1.20 | 0.966 |
| HDPE-1 | 0.95 | 0.958 |
| Maleic anhydride modified LLDPE | 2.7 | 0.91 |
| Tie layer blend | 1.3 | 0.918 |
| EVOH | 1.7 | 1.17 |
| EAA | 1.0 | 0.938 |
| Zn lonomer | 1.8 | 0.94 |

sLLDPE-1 is a commercially available, homogenous ethylene polymer sold by NOVA Chemicals Corporation known under the name SURPASS® FPs016-C. LLDPE-1 is a commercially available Z/N catalyzed polyethylene sold by NOVA Chemicals Corporation as SCLAIR® FP120-D. sHDPE-1 is a commercially available ethylene homopolymer sold by NOVA Chemicals Corporation as SURPASS® HPs167-AB. The sHDPE-1 used in these examples is prepared with a single site catalyst (containing Ti) and contained 1200 parts per million by weight (ppm) of a nucleating agent sold under the tradename HPN-20E by Milliken Chemical. s-HDPE-1 is further characterized in that: a) it is a blend of two HDPE components (each of which has an Mw/Mn of between about 2 and about 3), and; b) it has an Mw/Mn of about 8. HDPE-1 is a commercially available, Z/N catalyzed, ethylene homopolymer sold by NOVA Chemicals Corporation as SCLAIR® 19C. Maleic anhydride modified LLDPE is a commercially available resin from DuPont™ known as Bynel® 41E710. The tie layer blend consists of 20 weight % Bynel® 41E710 in SCLAIR® FP120-D. EVOH is a commercially available resin from Kuraray Company known as EVAL™ H171B. EAA is a commercially available resin from The Dow Chemical Company known as PRIMACOR™ 1410. Zn ionomer is a commercially available resin from DuPont™ known as Surlyn® 1650.

### Film Fabrication and Testing

The following 9-layer coextruded blown films were made on a coextrusion line that is manufactured by Brampton Engineering (of Brampton, Ontario).

All skin layers were formulated to contain the same level of slip, antiblock and processing aid.

Materials which have been employed for tie layers include functionally modified polyolefins (for example, Plexar, available from Equistar Chemicals) or an adhesive resin such as Bynel® from DuPont™ or Nucrel (an ethylene methacrylic acid copolymer) available from DuPont™. In the examples (above) the tie layers consist of 20% Bynel® 41E710 in SCLAIR® FP120-D.

The compositions of the films are shown in Table 2. For clarity, the heading “layer ratio” refers to the weight % of each layer and the “skin” layers are shown as the first and last columns. Thus, film 1.1 contains a first skin layer containing 15 weight % of s-LLDPE-1 and a second skin layer containing 15 weight % of LLDPE-1. The grease breakthrough resistance of these films is reported in Table 4.

TABLE 2
Film compositions

| | Resin Used In Respective Layer | | | | | | | | |
|---|---|---|---|---|---|---|---|---|---|
| Layer ratio: | 15 | 12 | 12 | 8 | 6 | 8 | 12 | 12 | 15 |
| FILM 1.1 | sLLDPE-1 | LLDPE-1 | LLDPE-1 | tie layer | EVOH | tie layer | LLDPE-1 | LLDPE-1 | LLDPE-1 |
| (comparative) | | | | blend | | blend | | | |
| FILM 1.2 | sLLDPE-1 | sHDPE-1 | sHDPE-1 | tie layer | EVOH | tie layer | sHDPE-1 | sHDPE-1 | LLDPE-1 |
| (comparative) | | | | blend | | blend | | | |
| Layer ratio: | 15 | 10 | 10 | 11 | 11 | 11 | 10 | 11 | 11 |
| FILM 1.3 | sLLDPE-1 | sHDPE-1 | sHDPE-1 | EAA | EAA | EAA | sHDPE-1 | sHDPE-1 | LLDPE-1 |
| (inventive) | | | | | | | | | |
| FILM 1.4 | sLLDPE-1 | sHDPE-1 | sHDPE-1 | Zn | Zn | Zn | sHDPE-1 | sHDPE-1 | LLDPE-1 |
| (inventive) | | | | Ionomer | Ionomer | Ionomer | | | |
| FILM 1.5 | sLLDPE-1 | 80% | 80% | EAA | EAA | EAA | 80% | 80% | LLDPE-1 |
| (inventive) | | sHDPE-1; | sHDPE-1; | | | | sHDPE-1; | sHDPE-1; | |
| | | 20% | 20% | | | | 20% | 20% | |
| | | LLDPE-1 | LLDPE-1 | | | | LLDPE-1 | LLDPE-1 | |
| FILM 1.6 | sLLDPE-1 | 80% | 80% | Zn | Zn | Zn | 80% | 80% | LLDPE-1 |
| (inventive) | | sHDPE-1; | sHDPE-1; | Ionomer | Ionomer | Ionomer | sHDPE-1; | sHDPE-1; | |
| | | 20% | 20% | | | | 20% | 20% | |
| | | LLDPE-1 | LLDPE-1 | | | | LLDPE-1 | LLDPE-1 | |
| Layer ratio: | 15 | 12 | 12 | 8 | 6 | 8 | 12 | 12 | 15 |
| FILM 1.7 | sLLDPE-1 | HDPE-1 | HDPE-1 | EAA | EAA | EAA | HDPE-1 | HDPE-1 | LLDPE-1 |
| (comparative) | | | | | | | | | |
| FILM 1.8 | LLDPE-1 | HDPE-1 | HDPE-1 | Zn | Zn | Zn | HDPE-1 | HDPE-1 | LLDPE-1 |
| (comparative) | | | | Ionomer | Ionomer | Ionomer | | | |
| FILM 1.9 | sLLDPE-1 | LLDPE-1 | LLDPE-1 | EAA | EAA | EAA | LLDPE-1 | LLDPE-1 | LLDPE-1 |
| (comparative) | | | | | | | | | |
| FILM 1.10 | sLLDPE-1 | LLDPE-1 | LLDPE-1 | Zn | Zn | Zn | LLDPE-1 | LLDPE-1 | LLDPE-1 |
| (comparative) | | | | Ionomer | Ionomer | Ionomer | | | |
| FILM 1.11 | sLLDPE-1 | LLDPE-1 | LLDPE-1 | LLDPE-1 | LLDPE-1 | LLDPE-1 | LLDPE-1 | LLDPE-1 | LLDPE-1 |
| (comparative) | | | | | | | | | |

A brief discussion of the performance of the films from Table 2 follows.

### Comparative Samples

Comparative samples FILM 1.1 and FILM 1.2 are generally accepted by those skilled in the art as typical, non-recyclable (i.e. EVOH containing), grease-resistant barrier films.

Comparative samples FILM 1.7, FILM 1.8 are films that contain the non-nucleated HDPE and show poor grease breakthrough resistance (Table 4).

Comparative samples FILM 1.9, FILM 1.10, and FILM 1.11 are films that do not contain HDPE and show very poor grease breakthrough resistance (Table 4).

### Inventive Samples

Inventive films FILM 1.3 and FILM 1.4 are recyclable, grease-resistant films.

Inventive films FILM 1.5 and FILM 1.6 are recyclable, grease-resistant films that contain layers in which the grease resistant layer was diluted with 20% LLDPE-1.

The films were subjected to the following tests:

Dart Impact Strength was measured on a dart impact tester (Model D2085AB/P) made by Kayness Inc., in accordance with ASTM D1709, Method A;

Film Tear Strength, Machine (MD) and Transverse (TD) Direction Elmendorf tear strengths were measured on a ProTear™ Tear Tester made by Thwing-Albert Instrument Co. in accordance with ASTM D-1922;

Puncture Resistance was measured on a MTS Systems Universal Tester (Model SMT (HIGH)-500N-192) in accordance with ASTM D-5748;

1% Secant Modulus (MD and TD) were measured on an Instrument 5-Head Universal Tester (Model TTC-102) at a crosshead speed of 0.2 in/min (0.508 cm/min) up to 10% strain in accordance with ASTM D-882-10. The 1% secant modulus (MD and TD) was determined by an initial slope of the stress-strain curve from an origin to 1% strain; Tensile properties, were measured on an Instrument 5-Head Universal Tester (Model TTC-102) in accordance with ASTM D-882-10;

Film grease resistance was measured as described below.

### Grease Breakthrough Test Method

The test method was based on procedures developed by Wyser and coworkers (See: “Novel Method for Testing the Grease Resistance or Pet Food Packaging”; J. Lange, C. Pelletier, Y. Wyser; Packaging Technology and Science; 2002; 15; 65-74). A 20 cm by 20 cm piece of film is placed over a 10 cm by 10 cm thin layer chromatography (TLC) plate in which the silica contains a fluorescent indicator (POLYGRAM© SIL G/UV254 available from Macherey-Nagel GmbH & Co. KG). A pre-heated stainless steel ring (with an inner diameter of 6 cm) is placed on the film and 2 g of lard is placed inside the ring. A pre-heated 2 kg piston (with an outer diameter of just under 6 cm) is placed inside the ring to apply pressure of approximately 7 kPa to the film. The apparatus is then placed inside an oven at the temperature that the piston and ring were treated to for 48 hours. The apparatus is removed from the oven and allowed to cool to room temperature. The plate is photographed in a viewing box with 254 nm light to determine the relative amount of grease breakthrough for the film. The grease absorbs light at 254 nanometers and will thus appear as dark regions on the TLC plate. The photograph is uploaded to image processing software (ImageJ) and the color image is converted to grey scale. The dark portion of the image from within the ring Corresponds to the fraction of grease breakthrough.

By way of further explanation, a totally grease resistant film would not show any dark area (and would be reported as having a grease breakthrough resistance value of 0) and a film with no grease resistance would be completely dark (and would be reported as having a grease breakthrough resistance value of 100).

As previously noted, a Cr-catalyzed grade of polyethylene has been sold for the preparation of grease resistant packaging. Table 15 shows that the grease breakthrough value of this film (comparative film, FILM 4.2) is 17% at 60° C. and that the nucleating agent improves this value to 4% (inventive example, FILM 4.3).

The use of nucleated HDPE to prepare an interior (or “core”) layer of a multilayer film is also within the scope of this disclosure and is illustrated in the examples. Table 8 also shows that the same nucleating agent provides exceptional grease breakthrough resistance when used with a titanium catalyzed polyethylene in 3 layer co-extruded blown films, as shown by FILM 2.1, which contains a nucleated HDPE and has a grease breakthrough value of 9% at 70° C. (see Table 8). The comparative FILM 2.2, which does not contain nucleating agent, shows a grease breakthrough value of 30% at 70° C. (see Table 8).

It should also be noted that the temperature at which the grease breakthrough test was conducted should be reported because the grease breakthrough resistance of a film can be influenced by the test temperature.

### Results

Additional properties of the films of Table 2 are reported in Table 3.

TABLE 3
Physical results:

| | FILM 1.1 | FILM 1.2 | FILM 1.3 | FILM 1.4 | FILM 1.5 |
|---|---|---|---|---|---|
| Physical Property | (comparative) | (comparative) | (inventive) | (inventive) | (inventive) |
| Dart Impact Strength (g/mil) | 95 | 53 | 130 | 162 | 129 |
| Slow Puncture - Lube/Tef (J/mm) | 43 | 36 | 34 | 25 | 31 |
| Tear Strength - MD (g/mil) | 177 | 285 | 68 | 207 | 128 |
| Tear Strength - TD (g/mil) | 235 | 103 | 266 | 63 | 268 |
| 1% Secant Modulus - MD (MPa) | 385 | 610 | 556 | 582 | 446 |
| 1% Secant Modulus - TD (MPa) | 391 | 659 | 628 | 684 | 498 |
| Tensile Break Strength - MD | 32.4 | 31.5 | 39.8 | 32 | 39.4 |
| (MPa) | | | | | |
| Tensile Break Strength - TD (MPa) | 27.7 | 24.3 | 38.9 | 28.6 | 36.1 |
| Elongation at Break - MD (%) | 589 | 593 | 611 | 452 | 619 |
| Elongation at Break - TD (%) | 559 | 503 | 669 | 479 | 647 |
| Tensile Yield Strength - MD (MPa) | 14.5 | 19.8 | 19.7 | 21.2 | 17.2 |
| Tensile Yield Strength - TD (MPa) | 14.5 | 20.3 | 20.9 | 21.4 | 17.7 |
| Tensile Elongation at Yield - MD | 14 | 10 | 9 | 9 | 10 |
| (%) | | | | | |
| Tensile Elongation at Yield - TD | 10 | 6 | 7 | 7 | 8 |
| (%) | | | | | |

| | FILM 1.6 | FILM 1.7 | FILM 1.8 | FILM 1.9 | FILM 1.10 | FILM 1.11 |
|---|---|---|---|---|---|---|
| Physical Property | (inventive) | (comparative) | (comparative) | (comparative) | (comparative) | (comparative) |
| Dart Impact Strength | 166 | 136 | 187 | 306 | 304 | 273 |
| (g/mil) | | | | | | |
| Slow Puncture - | 28 | 34 | 27 | 46 | 36 | 55 |
| Lube/Tef (J/mm) | | | | | | |
| Tear Strength - MD | 188 | 212 | 124 | 264 | 139 | 409 |
| (g/mil) | | | | | | |
| Tear Strength - TD | 63 | 226 | 53 | 229 | 97 | 546 |
| (g/mil) | | | | | | |
| 1% Secant Modulus - | 474 | 417 | 411 | 174 | 186 | 195 |
| MD (MPa) | | | | | | |
| 1% Secant Modulus - | 541 | 468 | 536 | 163 | 207 | 199 |
| TD (MPa) | | | | | | |
| Tensile Break Strength - | 30.3 | 40 | 30.5 | 30.8 | 27.4 | 47.3 |
| MD (MPa) | | | | | | |
| Tensile Break Strength - | 27 | 40.4 | 29.6 | 32.2 | 28.2 | 43.1 |
| TD (MPa) | | | | | | |
| Elongation at Break - | 428 | 615 | 427 | 484 | 387 | 618 |
| MD (%) | | | | | | |
| Elongation at Break - | 459 | 665 | 468 | 561 | 467 | 683 |
| TD (%) | | | | | | |
| Tensile Yield Strength - | 18.6 | 17.1 | 18.5 | 10.7 | 12.2 | 11 |
| MD (MPa) | | | | | | |
| Tensile Yield Strength - | 19.1 | 18.6 | 19.6 | 10.6 | 11.9 | 11.1 |
| TD (MPa) | | | | | | |
| Tensile Elongation at | 10 | 13 | 13 | 14 | 12 | 12 |
| Yield - MD (%) | | | | | | |
| Tensile Elongation at | 8 | 9 | 7 | 14 | 12 | 14 |
| Yield - TD (%) | | | | | | |

TABLE 4
Grease Breakthrough Resistance Test Results

Grease Breakthrough
Resistance values %
Oven temperature (° C.):

| Film | 70 | 60 | 50 | 40 |
|---|---|---|---|---|
| FILM 1.1 (comparative) | 1 | | | |
| FILM 1.2 (comparative) | 4 | | | |
| FILM 1.3 (inventive) | 4 | 1 | 0 | 0 |
| FILM 1.4 (inventive) | 16 | | | |
| FILM 1.5 (inventive) | 5 | | | |
| FILM 1.6 (inventive) | 12 | | | |
| FILM 1.7 (comparative) | 25 | 0 | 0 | 0 |
| FILM 1.8 (comparative) | 26 | | | |
| FILM 1.9 (comparative) | 44 | | | |
| FILM 1.10 (comparative) | 60 | | | |
| FILM 1.11 (comparative) | 45 | 20 | 12 | 0 |

### Part 2

### 3-Layer Films to Compare Nucleated and Non-Nucleated HDPE

The polymers used in this example are shown in Table 5. This example relates to 3-layer co-extruded blown films.

TABLE 5
Resin Properties

| Type | Melt Index, dg/min | Density, g/cc |
|---|---|---|
| LLDPE-1 | 1.0 | 0.920 |
| sHDPE-1 | 1.20 | 0.966 |
| HDPE-2 | 1.20 | 0.960 |
| sHDPE-2 | 1.20 | 0.966 |

LLDPE-1 and HDPE-1 are as previously described. HDPE-2 is a commercially available resin from NOVA Chemicals Corporation known as SCLAIR® 19G. sHDPE-2 is a homopolymer polyethylene that is essentially the same as sHDPE-1 but does not contain nucleating agent.

### Film Fabrication and Testing

Three layer co-extruded films (having an A/B/C layer structure, as shown in Table 6), were prepared on a blown film line manufactured by Brampton Engineering (of Brampton, Ontario, Canada) using the following conditions: 2.5:1 Blow Up Ratio (BUR), 102 mm (4 inch) die, 0.89 mm (35 mil) annular die gap and 45.4 kg/h (100 lbs/h) output rate. The straight feed extruder screws have 38.1 mm (1.5 inch) diameter and a length/diameter (L/D) ratio of 24/1. Typical extrusion temperatures are from 165 to 260° C., especially from 177 to 238° C. Screw speed is in the range of 35 to 50 revolutions per minute, RPM. The blown film bubble is air cooled. All skin layers were formulated to contain the same level of slip, antiblock and processing aid.

The total thickness of the three layer films is 89 microns (3.5 mils). Each skin layer makes up 25% of the total film thickness. The core layer makes up the remaining 50% of the film thickness.

TABLE 6
Film compositions

| Film | Layer A | Layer B | Layer C |
|---|---|---|---|
| FILM 2.1 (inventive) | LLDPE-1 | sHDPE-1 | LLDPE-1 |
| FILM 2.2 (comparative) | LLDPE-1 | sHDPE-2 | LLDPE-1 |
| FILM 2.3 (comparative) | LLDPE-1 | HDPE-2 | LLDPE-1 |
| FILM 2.4 (comparative) | LLDPE-1 | LLDPE-1 | LLDPE-1 |

Inventive film FILM 2.1 contains a nucleated HDPE as the barrier layer.

Comparative film FILM 2.2 contains an analogous HDPE layer as FILM 2.1 however sHDPE-2 is non-nucleated. At 60 and 70° C., the grease breakthrough resistance of FILM 2.2 is significantly worse than FILM 2.1 as seen in Table 8.

The grease breakthrough resistance of non-nucleated HDPE-2 is also poorer than sHDPE-1 as seen in the relative high Grease Breakthrough values of FILM 2.3 as seen in Table 8.

FILM 2.4 does not contain a HDPE and has poor grease breakthrough resistance even at 50° C.

Physical properties of the films are shown in Table 7.

TABLE 7
Film physical Results

| | FILM 2.1 | FILM 2.2 | FILM 2.3 | FILM 2.4 |
|---|---|---|---|---|
| Physical Property | (inventive) | (comparative) | (comparative) | (comparative) |
| Dart Impact Strength (g/mil) | 49 | 136 | 101 | 297 |
| Tear Strength - MD (g/mil) | 59 | 81 | 72 | 485 |
| Tear Strength - TD (g/mil) | 130 | 180 | 180 | 597 |
| 1% Secant Modulus - MD | 790 | 682 | 560 | 208 |
| (MPa) | | | | |
| 1% Secant Modulus - TD | 938 | 762 | 714 | 222 |
| (MPa) | | | | |
| Tensile Break Strength - | 40.2 | 36.2 | 38.4 | 41 |
| MD (MPa) | | | | |
| Tensile Break Strength - | 38.3 | 35.4 | 33.7 | 44.6 |
| TD (MPa) | | | | |
| Elongation at Break - MD | 923 | 900 | 939 | 888 |
| (%) | | | | |
| Elongation at Break - TD | 929 | 911 | 895 | 956 |
| (%) | | | | |
| Tensile Yield Strength - MD | 21.6 | 20.1 | 18.9 | 10.3 |
| (MPa) | | | | |
| Tensile Yield Strength - TD | 23.8 | 21.2 | 20.9 | 10.6 |
| (MPa) | | | | |
| Tensile Elongation at Yield - | 10 | 12 | 12 | 16 |
| MD (%) | | | | |
| Tensile Elongation at Yield - | 8 | 10 | 9 | 17 |
| TD (%) | | | | |

TABLE 8
Grease Breakthrough Resistance Test Results

Grease Breakthrough
Resistance Values %
Oven temperature (° C.):

| Film | 70 | 60 | 50 | 40 |
|---|---|---|---|---|
| FILM 2.1 (inventive) | 9 | 1 | 1 | 2 |
| FILM 2.2 (comparative) | 30 | 6 | 3 | 2 |
| FILM 2.3 (comparative) | 39 | 16 | 3 | 0 |
| FILM 2.4 (comparative) | 50 | 24 | 16 | 2 |

### Part 3

### 9-Layer Films for Use in Packaging

### Experimental

The resins used in this example are shown in Table 9. This example relates to 9-layer co-extruded blown films. The melt index, I₂, and density values of the resins in Table 9 are from product datasheets of respective resin grades published by the manufacturer of each resin.

TABLE 9
Resin Properties

| Type | Melt Index, dg/min | Density, g/cc |
|---|---|---|
| LLDPE-2 | 0.90 | 0.912 |
| sLLDPE-1 | 0.65 | 0.916 |
| LLDPE-1 | 1.0 | 0.920 |
| sHDPE-1 | 1.20 | 0.966 |
| HDPE-1 | 0.95 | 0.958 |
| Maleic anhydride modified LLDPE | 2.7 | 0.91 |
| Tie layer blend | 1.3 | 0.918 |
| EVOH | 1.7 | 1.17 |
| EAA | 1.0 | 0.938 |
| Zn lonomer | 1.8 | 0.94 |

LLDPE-2 is a commercially available resin from NOVA Chemicals Corporation known as SCLAIR® FP112-A. sLLDPE, LLDPE-1, sHDPE and HDPE-1 are as previously described. HDPE-2 is a commercially available resin from NOVA Chemicals Corporation known as SCLAIR® 19G. Maleic anhydride modified LLDPE is a commercially available resin from DuPont™ known as Bynel® 41E710. Tie layer blend consists of 20 weight % Bynel® 41E710 in SCLAIR® FP120-D. EVOH is a commercially available resin from Kuraray Company known as EVAL™ H171B. EAA is a commercially available resin from The Dow Chemical Company known as PRIMACOR™ 1410. Zn ionomer is a commercially available resin from DuPont™ known as Surlyn® 1650.

### Film Fabrication and Testing

The following 9-layer coextruded blown films were made on a coextrusion line manufactured by Brampton Engineering (Brampton, Ontario).

All skin layers were formulated to contain the same level of slip, antiblock and processing aid. The compositions of the films are shown in Table 10. For clarity, the heading “layer ratio” refers to the weight % of each layer and the “skin” layers are shown as the first and last columns. Thus, FILM 3.1 contains a first skin layer containing 15 weight % LLDPE-1 and a second skin layer containing 15 weight % LLDPE-2. The grease breakthrough resistance of these films are reported in Table 12.

TABLE 10
Film compositions:

| Film | Resins Resin Used In Respective Layer | | | | | | | | |
|---|---|---|---|---|---|---|---|---|---|
| Layer ratio: | 15 | 12 | 12 | 8 | 6 | 8 | 12 | 12 | 15 |
| FILM 3.1 | LLDPE-1 | LLDPE-1 | LLDPE-1 | sHDPE-1 | sHDPE-1 | sHDPE-1 | LLDPE-1 | LLDPE-1 | LLDPE-2 |
| (inventive) | | | | | | | | | |
| FILM 3.2 | LLDPE-1 | LLDPE-1 | LLDPE-1 | tie layer | EVOH | tie layer | LLDPE-1 | LLDPE-1 | LLDPE-2 |
| (comparative) | | | | blend | | blend | | | |
| FILM 3.3 | LLDPE-1 | sHDPE-1 | sHDPE-1 | tie layer | EVOH | tie layer | sHDPE-1 | sHDPE-1 | LLDPE-2 |
| (comparative) | | | | blend | | blend | | | |
| Layer ratio: | 11 | 11 | 10 | 11 | 11 | 11 | 10 | 10 | 15 |
| FILM 3.4 | LLDPE-1 | sHDPE-1 | sLLDPE-1 | sLLDPE-1 | sHDPE-1 | sLLDPE-1 | sLLDPE-1 | sHDPE-1 | LLDPE-2 |
| (inventive) | | | | | | | | | |
| FILM 3.5 | LLDPE-1 | sHDPE-1 | sHDPE-1 | EAA | EAA | EAA | sHDPE-1 | sHDPE-1 | LLDPE-2 |
| (inventive) | | | | | | | | | |
| FILM 3.6 | LLDPE-1 | sHDPE-1 | sHDPE-1 | Zn | Zn | Zn | sHDPE-1 | sHDPE-1 | LLDPE-2 |
| (inventive) | | | | ionomer | ionomer | ionomer | | | |
| FILM 3.7 | LLDPE-1 | sHDPE-1 | sLLDPE-1 | sLLDPE-1 | sLLDPE-1 | sLLDPE-1 | sLLDPE-1 | sHDPE-1 | LLDPE-2 |
| (inventive) | | | | | | | | | |
| FILM 3.8 | LLDPE-1 | sHDPE-1 | LLDPE-1 | LLDPE-1 | LLDPE-1 | LLDPE-1 | LLDPE-1 | sHDPE-1 | LLDPE-2 |
| (inventive) | | | | | | | | | |
| FILM 3.9 | LLDPE-1 | HDPE-1 | sLLDPE-1 | sLLDPE-1 | HDPE-1 | sLLDPE-1 | sLLDPE-1 | HDPE-1 | LLDPE-2 |
| (comparative) | | | | | | | | | |
| Layer ratio: | 11 | 8 | 12 | 12 | 10 | 12 | 12 | 8 | 15 |
| FILM 3.10 | LLDPE-1 | sHDPE-1 | sLLDPE-1 | sLLDPE-1 | sLLDPE-1 | sLLDPE-1 | sLLDPE-1 | sHDPE-1 | LLDPE-2 |
| (inventive) | | | | | | | | | |

### Comparative Samples

FILM 3.2 (comparative) and FILM 3.3 (comparative) are generally accepted by those skilled in the art as typical, non-recyclable grease resistant barrier film.

FILM 3.9 (comparative) is a film that contains the non-nucleated HDPE and has poor grease breakthrough resistance.

### Inventive Samples

FILM 3.7 (inventive), FILM 3.8 (inventive), and FILM 3.10 (inventive) are structures that could be used as packaging films as they have good grease barrier properties and good film physical properties such as toughness and stiffness as demonstrated from Table 11 with their high dart impact strengths and balance of MD and TD secant moduli.

FILM 3.1 (inventive) and FILM 3.4 (inventive) have excellent grease barrier properties; all layers of these films contain polyolefins. The grease breakthrough resistance properties of FILM 3.1 and FILM 3.4 are equivalent to those of the comparative films FILM 3.2 and FILM 3.3 that are generally accepted to those skilled in the art as good grease barrier films; however, these films are not recyclable.

The physical properties of the films are shown in Table 11. The grease breakthrough resistance of these films are reported in Table 12.

TABLE 11
Results:
Physical tests

| | FILM 3.1 | FILM 3.2 | FILM 3.3 | FILM 3.4 | FILM 3.5 |
|---|---|---|---|---|---|
| Physical Property | (inventive) | (comparative) | (comparative) | (inventive) | (inventive) |
| Dart Impact Strength (g/mil) | 165 | 123 | 61 | 168 | 177 |
| Puncture Resistance (J/mm) | 62 | 53 | 32 | 77 | 85 |
| Tear Strength - MD (g/mil) | 314 | 207 | 81 | 204 | 116 |
| Tear Strength - TD (g/mil) | 427 | 345 | 89 | 304 | 153 |
| 1% Secant Modulus - MD (MPa) | 490 | 417 | 980 | 543 | 652 |
| 1% Secant Modulus - TD (MPa) | 534 | 433 | 1064 | 599 | 749 |
| Tensile Break Strength - MD (MPa) | 34.5 | 20.6 | 17.1 | 33.2 | 26.8 |
| Tensile Break Strength - TD (MPa) | 38.1 | 18.7 | 17.5 | 35.1 | 27.3 |
| Elongation at Break - MD (%) | 992 | 619 | 272 | 871 | 689 |
| Elongation at Break - TD (%) | 1000 | 571 | 267 | 898 | 742 |
| Tensile Yield Strength - MD (MPa) | 15.6 | 14.5 | 25.9 | 16.9 | 19.6 |
| Tensile Yield Strength - TD (MPa) | 16.5 | 14.4 | 26.5 | 17.7 | 21 |
| Tensile Elongation at Yield - MD (%) | 14 | 14 | 10 | 12 | 11 |
| Tensile Elongation at Yield - TD (%) | 12 | 15 | 8 | 11 | 9 |

| | FILM 3.6 | FILM 3.7 | FILM 3.8 | FILM 3.9 | FILM 3.10 |
|---|---|---|---|---|---|
| Physical Property | (inventive) | (inventive) | (inventive) | (comparative) | (inventive) |
| Dart Impact Strength (g/mil) | 182 | 176 | 160 | 163 | 189 |
| Puncture Resistance (J/mm) | 28 | 74 | 70 | 80 | 66 |
| Tear Strength - MD (g/mil) | 485 | 298 | 319 | 291 | 354 |
| Tear Strength - TD (g/mil) | 97 | 396 | 486 | 291 | 481 |
| 1% Secant Modulus - MD (MPa) | 715 | 422 | 449 | 426 | 352 |
| 1% Secant Modulus - TD (MPa) | 806 | 470 | 500 | 498 | 394 |
| Tensile Break Strength - MD (MPa) | 23.8 | 36.2 | 35.3 | 40.8 | 38.7 |
| Tensile Break Strength - TD (MPa) | 21.7 | 35.4 | 39.2 | 38 | 39.6 |
| Elongation at Break - MD (%) | 522 | 906 | 926 | 978 | 921 |
| Elongation at Break - TD (%) | 576 | 901 | 980 | 953 | 954 |
| Tensile Yield Strength - MD (MPa) | 21.5 | 14.4 | 15 | 15.4 | 13.3 |
| Tensile Yield Strength - TD (MPa) | 22.8 | 15.1 | 16 | 15.9 | 14 |
| Tensile Elongation at Yield - MD (%) | 11 | 13 | 13 | 16 | 15 |
| Tensile Elongation at Yield - TD (%) | 10 | 13 | 12 | 12 | 14 |

TABLE 12
Grease Breakthrough Resistance Test Results

Grease Breakthrough Resistance
Value %
Oven temperature (° C.)

| Film | 70 | 60 | 50 | 40 |
|---|---|---|---|---|
| FILM 3.1 (inventive) | 15 | 4 | 3 | 3 |
| FILM 3.2 (comparative) | 7 | 5 | 3 | 2 |
| FILM 3.3 (comparative) | 5 | 2 | 1 | 1 |
| FILM 3.4 (inventive) | 5 | 3 | 1 | 3 |
| FILM 3.5 (inventive) | 4 | 2 | 1 | 0 |
| FILM 3.6 (inventive) | 10 | 4 | 2 | 1 |
| FILM 3.7 (inventive) | 9 | 4 | 4 | 2 |
| FILM 3.8 (inventive) | 7 | 7 | 2 | 1 |
| FILM 3.9 (comparative) | 28 | 5 | 4 | 3 |
| FILM 3.10 (inventive) | 38 | 7 | 2 | 1 |

### Part 4

### Monolayer Films

The polymers used in this example are shown in Table 13.

TABLE 13
Resin Properties

| Type | Melt Index, dg/min. | Density, g/cc |
|---|---|---|
| sHDPE-1 | 1.20 | 0.966 |
| HDPE-3 | 0.4 | 0.949 |
| HDPE-4 | 0.4 | 0.949 |

sHDPE-1 is as previously described. HDPE-3 is a commercially available resin from NOVA Chemicals Corporation known as NOVAPOL® HF-Y450-A. This is a Cr catalyzed polyethylene that has been sold for use in the preparation of grease resistant packaging for many years. HDPE-4 is a binary blend of HDPE-3 and 1060 ppm of Hyperform® HPN-20E a commercially available nucleating agent from Milliken Chemical.

### Film Fabrication and Testing

The films of the current examples (FILM 4.1, FILM 4.2, and FILM 4.3) were made on a blown film line manufactured by Battenfeld Gloucester Engineering Company (of Gloucester, Mass.) using a die diameter of 102 mm (4 inches), and a die gap of 0.889 mm (35 mil). This blown film line has a standard output of 45.4 kg/h (100 pounds per hour). Screw speed was set at 42 RPM. The extruder screw has a 63.5 mm (2.5 inches) diameter and a length/diameter (L/D) ratio of 24/1. Melt temperature and Frost Line Height are in the range of 215 to 227° C. (420 to 440° F.) and 0.381 to 0.457 m (15-18 inches), respectively. The blown film bubble is air cooled. An annular die having a gap of 0.889 mm (35 mils) was used for these experiments. The films of this example were prepared using a BUR aiming point of 2.5:1 and a film thickness aiming point of 64 microns (2.5 mils).

TABLE 14
Monolayer Blown Film Samples

| Film | Resin |
|---|---|
| FILM 4.1 (inventive) | sHDPE-1 |
| FILM 4.2 (comparative) | HDPE-3 |
| FILM 4.3 (inventive) | HDPE-4 |

The grease breakthrough resistance of these films is shown in Table 15.

TABLE 15
Grease Breakthrough Resistance Test Results

| | Grease Breakthrough | | |
|---|---|---|---|
| | Resistance Value % | | |
| | Oven | | |
| | temperature (° C.): | | |
| Film | 60 | 50 | 40 |
| FILM 4.1 (inventive) | 2 | 1 | 1 |
| FILM 4.2 (comparative) | 17 | 1 | 2 |
| FILM 4.3 (inventive) | 4 | 3 | 4 |

What is claimed is:

1. A method for improving the grease breakthrough resistance of a polyethylene package, said method comprising:
contacting grease with a package having at least one layer that is prepared from a compound comprising
a high density polyethylene composition having a density of from about 0.95 to about 0.97 g/cc, as determined by ASTM D-1505; and
a nucleating agent in an amount of from about 500 to about 5000 parts per million by weight, based on the weight of said high density polyethylene composition;
wherein said package has an improvement in grease breakthrough resistance in comparison to a package that is made from the same high density polyethylene composition but does not contain said nucleating agent.

2. The method of claim 1 wherein said nucleating agent is the calcium salt of 1,2 cyclohexane dicarboxylic acid.

3. The method of claim 1 wherein said high density polyethylene composition has a melt index, as determined by ASTM D-1238 at 190° C. and 2.16 kg of from about 0.01 to about 10 grams per 10 minutes.

4. The method of claim 1 wherein said high density polyethylene composition is prepared with a metal containing catalyst and where said metal is selected from the group consisting of Cr and group IV transition metals.

5. The method of claim 4 wherein said metal is selected from the group consisting of Cr and Ti.

6. The method of claim 1 wherein said high density polyethylene composition comprises a blend of at least two high density polyethylene blend components.

7. The method of claim 6 wherein at least one of said high density polyethylene blend components has a molecular weight distribution, Mw/Mn, of from about 2 to about 3.

8. The method of claim 7 wherein said high density polyethylene composition has an overall molecular weight distribution, Mw/Mn, of from about 5 to about 15.

9. The method of claim 1 wherein said high density polyethylene composition has a density of from about 0.96 to about 0.97 g/cc.

10. The method of claim 1 wherein said package is prepared from a film.

11. The method of claim 1 wherein said package is prepared by one or more of the following processes; extrusion blown film, extrusion cast film, extrusion molding, blow molding, injection molding, calendaring, profile extrusion, extrusion lamination and extrusion coating.

12. The method of claim 1 wherein said package has a multilayer structure.

13. The method of claim 10 wherein said package comprises a multilayer film having a first skin layer, a second skin layer and at least one internal layer, wherein
i) said first skin layer is a sealant layer;
ii) said at least one internal layer comprises
a high density polyethylene composition having a density of from about 0.95 to about 0.97 g/cc; and
a nucleating agent in an amount of from about 500 to about 5000 parts per million by weight, based on the weight of said high density polyethylene;
iii) said second skin layer is an abuse resistant layer; and
wherein said package has an improvement in grease breakthrough resistance in comparison to a package that is made from the same multilayer film but does not contain said nucleating agent in said internal layer.

14. A package containing grease wherein said package comprises at least one layer that is prepared from a compound comprising:
a high density polyethylene composition having a density of from about 0.95 to about 0.97 g/cc, as determined by ASTM D-1505; and
a nucleating agent in an amount of from about 500 to about 5000 parts per million by weight, based on the weight of said high density polyethylene composition;
wherein said package has an improvement in grease breakthrough resistance in comparison to a package that is made from the same high density polyethylene composition but does not contain said nucleating agent.

15. The package of claim 14, wherein said grease comprises one or more of plant derived fats, plant derived oils, animal derived fats, animal derived oils, petroleum derived oils, petroleum derived asphaltsand petroleum derived greases.

16. The method of claim 13 wherein said at least one internal layer includes at least one layer that is prepared from a recyclable polymer; wherein said recyclable polymer comprises one or more of, a polyethylene having a density of from 0.88 to 0.97 g/cc; a homogeneously branched substantially linear ethylene interpolymer (HBSLEIP), a single site catalyzed linear low density polyethylene (sLLDPE), a high density polyethylene (HDPE), a LDPE, an EAA, an EMA, an ionomer and an EVA.

17. The method of claim 13 wherein said at least one internal layer includes at least one layer comprising a non-polyolefin material; wherein said non-polyolefin material comprises one or more of PET, EVOH, polyamide and PVDC.

18. The method of claim 13 wherein said first skin layer and said second skin layer are independently prepared from a polyolefin composition; wherein said polyolefin composition comprises one or more of a homogenously branched polyethylene having a density of from 0.90 to 0.93 g/cc, a heterogeneously branched polyethylene having a density of from 0.90 to 0.93 g/cc, a homogeneously branched substantially linear ethylene interpolymer (HBSLEIP), a single site catalyzed linear low density polyethylene (sLLDPE), a high density polyethylene (HDPE), a LDPE, an EAA, an EMA, an ionomer, an EVA, a polypropylene homopolymer and a polypropylene copolymer; and said at least one internal layer comprises a Ti catalyzed polyethylene having a density of from about 0.960 to about 0.967 g/cc, a melt index, I₂, of from about 0.5 to about 5 grams per 10 minutes, as determined by ASTM D-1238 at 190° C., and a Mw/Mn of from about 5 to about 15.

19. The package of claim 14 selected from the group consisting of a food package, a pet food package and a heavy duty sack.

20. The method of claim 1 wherein said improvement in grease breakthrough resistance is an improvement of from 10% to 30% at a temperature of 60° C.

21. The method of claim 4 wherein said metal is Ti
